(19) United States
(12) Patent Application Publication
(10) Pub. No.: US 2011/0185814 A1
(43) Pub. Date: Aug. 4, 2011

(54) METHOD FOR NON-DESTRUCTIVE INVESTIGATION OF THE BOTTOM OF METALLIC TANK STRUCTURES

(75) Inventor: Mauro Piccolo, Portogruaro (VE) (IT)

(73) Assignee: A.E.T. International S.r.l.

(21) Appl. No.: 12/737,514

(22) PCT Filed: Aug. 8, 2008
(86) PCT No.: PCT/IT2008/000542

§ 371 Date: Apr. 13, 2011

(51) Int. Cl. G01N 29/14

(52) U.S. Cl. 73/587

(57) ABSTRACT

The present invention relates to a method for non-destructive investigation of the bottom of metallic tank structures, comprising the following steps:
a) positioning an acoustic sensor at a point of contact between the tank wall and the bottom;
b) submitting the structure to induced acoustic emission signals caused by a source of energy in close proximity with the position of the acoustic sensor;
c) collecting data by the sensor and recording it;
d) moving to a different position at an interval of 0.1-1.0 m along the perimeter of the tank bottom;
e) repeating steps a)-d) until the entire perimeter of the bottom of the tank is investigated;
f) determining the position and amplitude of all the defects, by considering the physical-mechanical features of the metal, the geometry of the tank, the propagation time of the backscattered signals determined by the defects and the amplitude of deviations of emission frequencies;
f) performing the spectral analysis and data interpretation by considering the physical-mechanical features of the metal, the features of the induced acoustic emission signals, in particular the shift of the resonance frequencies of induced acoustic emission signals against the etalon values of frequencies of the intact metal and against etalon values specific for different types of degradation processes.

The present invention concerns a method for non-destructive investigation of the bottom of metallic tank structures.

More in particular, the present invention refers to non-destructive investigations of metallic tank structures, identification of flaws and weak points, corrosion and micro-fractures. The invention also relates to the calculation of the residual life of the structure of the tank.

It is well known that breakdown of integrity of tanks and reservoirs, used in oil and gas or nuclear power and chemical industry, may often cause large-scale ecological catastrophes resulting in significant damages and losses. Even if the majority of onshore oil spills occurred worldwide has not been recorded and comprehensive data is not available, the existing information gives sufficient ground to make some important conclusions. According to a worldwide survey made by the American Petroleum Institute (API), storage tank ruptures accounted for 5% of the 132 most significant releases that occurred worldwide between 1970 and 1988 but accounted for almost 19% of the released material. Tanks that contain a large amount of hazardous materials are often located in areas of environmental value or are close to the community and, therefore, impose significant risk to the environment and human health if not properly managed.

The most important cause of the aboveground storage tank leakages is related to the tank bottom damage and, in particular, the under-floor corrosion and non-corrosion related flaws.

The integrity of tanks and particularly of tank bottoms needs to be well managed; the inspection program needs to demonstrate that tanks are not leaking and any leakage should be excluded before the next inspection is carried out. The cost of clean up, environmental damage and adverse publicity as a result of oil releases spawned present tank regulations and the development of API 653 standard by the American Petroleum Institute. Although API 653 is not mandatory in most countries, it has the standing of “good industry practice”. API 653 employs “time based” approach as a tank inspection strategy, which means taking tanks out of service at set intervals. According to regulation API 653 it is recommended to inspect the tank floor plates by different techniques among which scanning by magnetic flux exclusion (MFE) with ultrasonic follow-up of suspect areas is comprised.

Both inspection techniques require the floor to be dry and free of sludge, dirt, sediments and corrosion products and therefore need opening and cleaning of the tank before testing.

On one hand, a significant problem of these techniques is that “time-based” maintenance practice (and particularly API 653) does not safeguard against oil spills and relevant damages; on the other hand the biggest failure of time-based maintenance is that enormous resources are wasted on opening and cleaning tanks for inspection, in cases where there is nothing wrong and no repairs are needed. It is usually found that tank integrity assurance costs are dominated by cleaning/sludge removal activities prior to inspection and application of confined space entry precautions, rather than by inspection costs. Saudi Aramco reported that more than US$50 million would be saved annually by avoiding the tank cleaning and inspections on tanks where no repairs were actually required. Inspection of underground storage tanks is related to even more difficulties and expenses.

Therefore, on this base many researchers have been moved to the development of new reliable inspection technologies to enable in-service inspection of the tanks without opening and cleaning and solving keeping in mind that according to ASTM E610, it is typical for acoustic emission measurement to have the absence of detectable acoustic emission until previously applied stress levels are exceeded. This is a critical issue for reliable detection of defect-related acoustic emission signal for the tanks and pipelines, usually tested before commissioning in overloaded and overstressed conditions.

The main task of this type of investigation, when used for the control of metal structures, is the early and reliable detection of flaws, the determination of size and location of defects and the estimation of the residual life of the structure.

Various non-destructive test methods are used for diagnosis of metal constructions; the most common technologies, used in standard inspection procedures, are: x-ray defectoscopy, ultrasonic defectoscopy, magneto-metric defectoscopy, and traditional methods of acoustic emission.

Inspection of metal constructions through application of X-ray, ultrasonic or magnetometric defectoscopy requires scanning of the entire surface of the tested area. This is a time-consuming and expensive exercise when objects are large and bi- or tri-dimensional (e.g.: above-ground reservoirs, bodies of vessels, submarines, reactors, long segments of oil and gas pipelines or railways).

In general, the surface of the metal has to be cleaned or specially prepared and sections of the test-object, which are difficult to access for direct contact, can not be inspected.

X-ray, ultrasonic and magnetometric defectoscopy could be successfully applied to inspect current state of metal constructions (identification, location and description of defects) but they lack a precise and reliable estimation of the object's residual life to determine its safe operational conditions and require a close spaced sampling and direct contact with the portion containing the defect.

The conventional method of acoustic emission, unlike the above-mentioned methodologies, does not require the scanning of the whole surface of the investigated object (Ohira, t. Pao, Y-H. Microcrack initiation and AE of 533B steel in fracture toughness tests J Acous Emiss 4 (1985) pS 274; Kim, K. H. Kishi, T. Three dimensional AE source location in metals NDT Comm 3 (1987) p 75; 3 R. W. Evans and B. Wilshire. Creep of metals and alloys, Institute of Metals, London. 1985; D. Racko Acoustic Emission from Welds as indicator of Cracking Mat. Scie. and Tecn. 3, 1062 (1987); Ian G. Scott, Basic Acoustic Emission Nondestructive Testing, NTM and Tracts, Vol 6, Gordon and Breach Science Publishers, 1991; A. Petri, G. Paparo, A. Vespignani, A. Alippi, and M. Costantini, Experimental Evidence for Critical Dynamics in Microfracturing Processes, Phys. Rev. Lett. 73, 3423 (1994); Prima Bertani, Experimental investigation into the capabilities of acoustic emission for the detection of shaft-to-seal rubbing in large power generation turbines: a case study, Proceedings of the Institution of Mechanical Engineers, Part J: Journal of Engineering Tribology, Professional Engineering Publishing, 1350-6501; K. Darowicki, A. Mirakowski and S. Krakowiak, Investigation of pitting corrosion of stainless steel by means of acoustic emission and potentiodynamic methods, Department of Anticorrosion Technology, Chemical Faculty, Gdansk University of Technology, 80-952 Gdansk, 11/12, Narutowicza Str., Poland); consequently, access to the surface for scanning of large dimensions of investigated object does not limit its application.

It implies “passive listening” of the object and, unlike ultrasonic method, it does not make active sounding of the structure by using generated signals. During traditional acoustic emission testing, the amplitude characteristics of acoustic waves generated by developing defects are measured and sometimes the structure is loaded and unloaded or stressed to generate the required signal.

Unfortunately, the development of chemical corrosion generates almost no detectable noise and can consequently be almost impossible to detect.

Therefore, conventional acoustic emission method can help in identifying only those defects that are developing or are active during the testing process, namely defects caused by active corrosion or micro cracks developing under the conditions of artificial loading of the structure beyond its service load.

Moreover, the conventional acoustic emission method has the following disadvantages:
it can not be used for detecting mechanical defects (de-lamination, segregation, cracks, pits caused by metal loss, structural liquefaction etc.) unless a special loading tests is applied, when the structure is overstressed;
it is characterised by “the absence of detectable acoustic emission until previously applied stress levels are exceeded” (this is a critical issue for the reliable detection of defect-related acoustic emission signal for tanks and pipelines, usually tested before commissioning in overloaded and overstressed conditions);
it can detect only active corrosion, i.e. the method fails to identify corrosion-related defects if the active corrosion is stopped at the moment of testing;
it cannot be used for determining through-holes in either a tank floor or wall of pipeline, unless they are actually leaking, thus it cannot help in detecting holes plugged by sludge, debris, wax or insulation materials;
the procedure requires isolation of a test-object from the exposure to extraneous noise for the period of testing, for this reason, from 6 to 24 hours prior to investigation, depending on dimensions of the reservoir, it is necessary to close valves, switch off heating systems and mixers.

This technology is based on measuring the amplitude characteristics of acoustic emissions, which easily attenuate in the mass of material and actually present the least noise-resistant parameters.

According to the Russian patent N. RU 2191377, relating to a method for determining residual service life of metallic mechanical systems by analysis of response to a non-destructive acoustic emission, Correct prediction of residual service life of mechanical systems is achieved by analysis of the following initial physical and mechanical properties of the type of metal (etalon): σₛ—temporary tensile strength; σ_{ys}—yield strength; ψᵣₐ—reduction of area; δₑₗ elongation; ρ_{md}—metal density; C*_{L}—longitudinal sound velocity (Pwave) and C*_{S} (Swave) shear sound velocity. Joint analysis of all ranges of acoustic emission frequencies is conducted by the study of: resonance frequency in range fₛₕ₋ₛ=1600-2500 Hz for the determination of shear separation combined by change of friction angle among structural inhomogeneities of the natural roughness ds I (i.e.: steel) ρ*=0.5[arctg(ψᵣₐ/δₑₗ)+16°], degrees in range ρ*=16°-50°, refer to metal degradation, and are also evaluated by the decrease of values of cyclic crack resistance K_{1c-f}. By the analysis of these specified change ρ* up to 45 degrees can be identified and is considered in the calculation of the residual life time together with past operational time T₁: Also the typical characteristic of amplitudes of acoustic emission frequencies fₛₕ₋ₛ, fₘₚ and f_{mc}, related to shear-separation stress Tₛₕ₋ₛ, are considered in the calculation of residual life _{Δ}Tn.

The theory underlying this method was deeply discussed by A. A Dzidziguri, L. SH Gavasheli, “Mathematical description and analysis of statistical and dynamical characteristics of elastic-damping materials”, Soobshenia ANGCCR, Tbilisi, N1988 page 41-44, the teachings of which are herein enclosed by reference.

In this context is presented the solution according to the present invention the aim of which is to present a method for non-destructive investigation of the bottom of metallic tank structures that can be used to reliably determine the size and position of defects that can be applied without the need of putting the tank of service as well as expensive and time-consuming preliminary preparatory works.

A further aim of the invention is that said method can be performed assuring absolute safety for the personnel in charge of its execution.

Not last aim of the invention is that of realising a method that is substantially simple, safe and reliable.

It is therefore a specific object of the present invention a method for non-destructive investigation of the bottom of metallic tank structures that comprises the following steps:

a) positioning an acoustic sensor at a point of contact between the tank wall and the bottom;

b) submitting the structure to induced acoustic emission signals caused by a source of energy in close proximity with the position of the acoustic sensor;

c) collecting data by the sensor and recording it;

d) moving to a different position at an interval of 0.1-1.0 m along the perimeter of the tank bottom;

e) repeating steps a)-d) until the entire perimeter of the bottom of the tank is investigated;

f) determining the position and amplitude of all the defects, by considering the physical-mechanical features of the metal, the geometry of the tank, the propagation time of the backscatterd signals determined by the defects and the amplitude of deviations of emission frequencies;

f) performing the spectral analysis and data interpretation by considering the physical-mechanical features of the metal, the features of the induced acoustic emission signals, in particular the shift of the resonance frequencies of induced acoustic emission signals against the etalon values of frequencies of the intact metal and against etalon values specific for different types of degradation processes.

According to the present invention, the method can further comprise a preliminary step of cleaning of the annular space at the contact between the tank wall and the bottom to permit a good coupling of the sensor with the metal.

Moreover, according to the invention, said induced acoustic emission signals are submitted in six different frequency ranges from 0-16; 16-50; 50-450; 450-1900; 1900-2700 and 2700-50000 Hz and said source of energy is a small hammer having a focusing system like Fresnel's zonal screen and a triggering device.

Always according to the present invention, the method for non-destructive investigation of the bottom of metallic tank structures comprises an algorithm for the automation of the process of spectral analysis and data interpretation.

Further, according to the invention, a data acquisition system connected with the sensor can be installed on an electronic calculator, also implementing a database containing physical-mechanical features of different metals and performing said algorithm.

The invention will be described in the following for illustrative, non-limitative purposes, with particular reference to some illustrative examples and to the figures of the enclosed drawings, wherein:

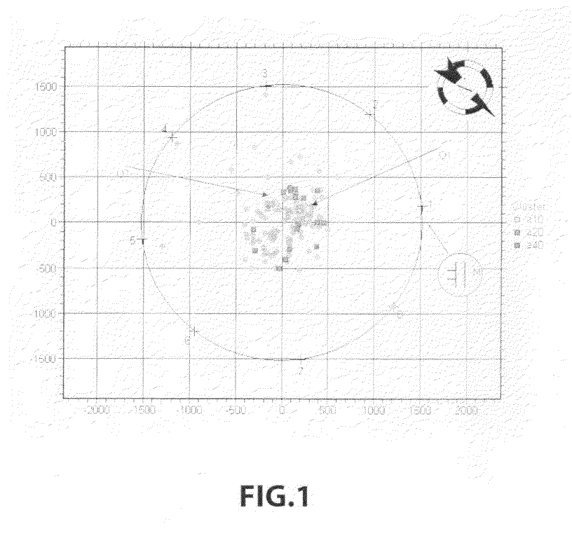

FIG. 1 shows a two-dimensional representation of the bottom of the tank of example 1, with indication of the positioning of the source of energy, as obtained by the investigation method based on acoustic emission analysis,

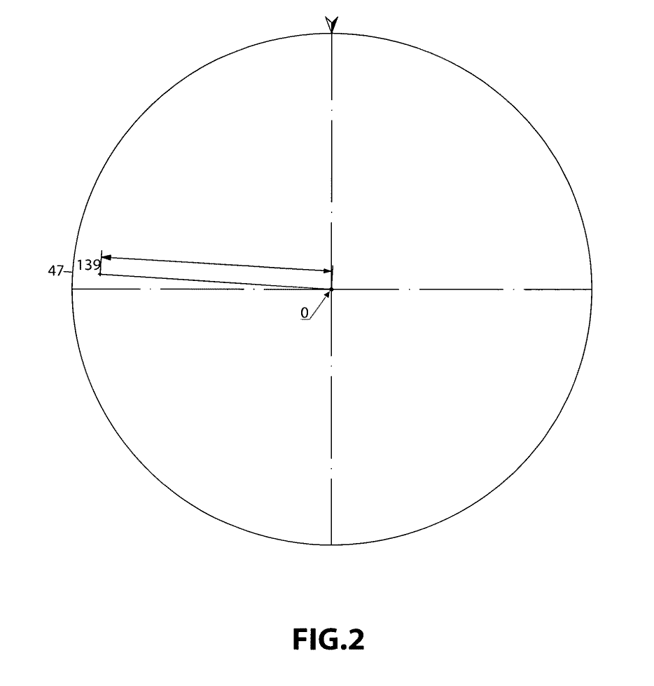

FIG. 2 shows the identification of a defect on the surface of the bottom of a tank, on the base of vector coordinates,

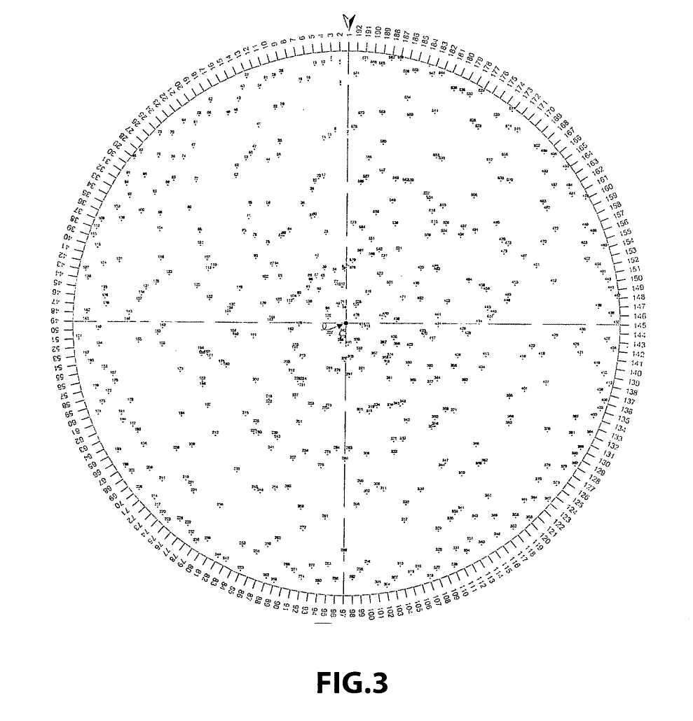

FIG. 3 shows the mapping of the bottom of the tank of example 1, as obtained through the application of the method of the invention, wherein corrosion points and corresponding detected values are shown,

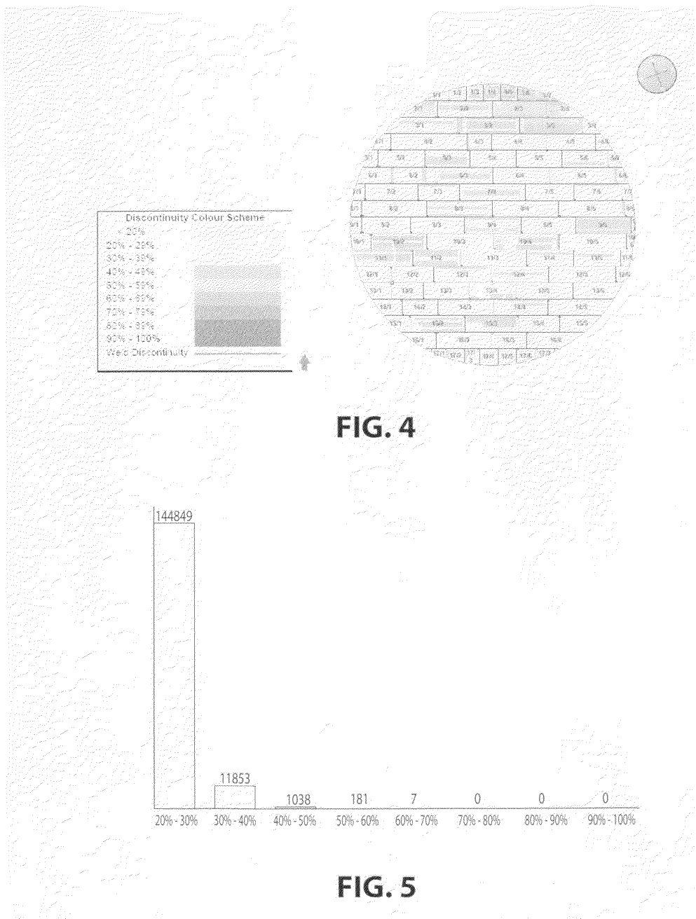

FIG. 4 shows the mapping of the bottom of the tank of example 1 with the distribution of the percentages of residual thickness on the bottom itself obtained by means of Magnetic Flow inspection or Floormap (in the following MFL),

FIG. 5 shows the statistics of the number of discontinuity inside the tank, and

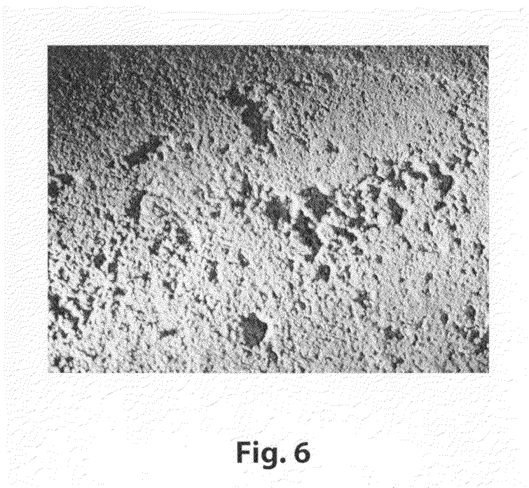

FIG. 6 shows a photographic image of a crater due to the corrosion of the bottom of the tank of example 1.

The method for non-destructive investigation of the bottom of metallic tank structures according to the present invention is based on a technique that will be called in the following with the acronym C.I.A.E.T., standing for Compulsorily Induced Acoustic Emission Technique.

C.I.A.E.T. records and analyzes the spectral densities of acoustic-emission signals induced as a response of the microstructures of the tested object to an external excitation at level of quantum of acoustic energy called “phonons”. The methodology analyses the changes of frequency characteristics of induced acoustic emission signals in six different frequency ranges from 0-16; 16-50; 50-450; 450-1900; 1900-2700 and 2700-50000 Hz and deviations of emission frequencies from etalon intact metal emission characteristics.

This testing method comprises an algorithm to enable the automation of the process of spectral analysis and data interpretation. In particular, the algorithm establishes correlations between induced acoustic emission signals and physical-mechanical parameters of metals, particularly with the coefficient of inhomogeneity of structural frictions, according to the method of A. A Dzidziguri and L. SH Gavasheli previously referred to. The algorithm permits to detect and locate defects, to evaluate the intensity and characters of degradation and to calculate the residual life of the object.

In particular, this testing method is based on the fact that breakdown of metal continuity at different stages of metal degradation is accompanied by specific shift of the resonance frequencies of induced acoustic emission signals against the etalon values of frequencies of the intact metal. Values of frequencies for different types of intact metals are determined and are used in C.I.A.E.T. shifts of resonance frequencies against etalon values specific for different types of degradation processes. The shifts of resonance frequencies within each of said six frequency ranges provide specific and complementary information about structural changes inside the object and can be used for description of flaw development. The performances of C.I.A.E.T. are not limited to the detection of defects and their location but it also enables to make prognosis of flaw development and to estimate the residual life of the object according to the method of A. A Dzidziguri and L. SH Gavasheli previously referred to.

The investigation is carried out using acoustic sensors specially adapted for this use and interlaced to a data acquisition system installed on a computer.

The source of energy is a small hammer. The excitation and recording are set at an interval of 0.1-1.0 m, depending to the dimension of the tank and the required detail, along the perimeter of the tank in correspondence of the external part of the floor to guarantee a good coverage of the entire surface of the floor.

The first step of the method for non-destructive investigation of the bottom of metallic tank structures of the present invention is the cleaning of the annular space at the contact between the tank wall and the bottom to permit a good coupling of the sensor with the metal.

The second step is the identification of an origin point and the setting of the sequence of excitation points according to the set intervals. The origin point can be located in correspondence of manhole to facilitate its location from inside the tank during the verification.

As far as the interval between the different excitation points is concerned, it is chosen taking into consideration a compromise between accuracy of the results and time needed in order to complete the test. By way of example, tanks with a diameter of 30 m can be sufficiently covered by a sequence of about 200 points, tanks with a diameter of 50 m by about 300 points and tanks with a diameter of 80 m can require about 500 excitation/recording points.

Due to this sampling interval, the tank bottom is divided in a number of cells having the dimensions of the sampling interval, for example if an interval of 0.5 m is used between energization points, cells will have a dimension of 50×50 cm, giving respectively about 2800, 9100 and 12000 cells for tanks with a 30, 54 and 80 m diameter.

As in a tomographic investigation, each cell is interested by different ray-paths and the contribution of the different ray-paths characteristics permits to solve the complicate matrix formed by all cells.

The sensors were located in contact with the tank bottom and the excitation occurred in the proximity of the sensor.

Sending signals from the circumference at close intervals allows the full coverage of the floor due to the complete propagation of the signal from one side of the tank to the other. Signals travel into the metal at ultrasonic speed with a spherical propagation front having a width depending on the propagation time and velocity of the signal.

The algorithm considers only a pre-set part of this front of propagation equivalent to the distance between energization points. If a 50 cm interval is selected, the propagation front will have a width of 50 cm calculated along the direction of propagation.

Consequently the tank floor will be covered by a series of paths, 50 cm wide having origin at the circumference and propagating toward the centre allowing the full coverage of the tank floor.

The sampling continues until the entire perimeter is investigated; the sampling interval is consequently able to provide a total and complete coverage of the surface of the bottom of the tank.

The excellent propagation of this type of signals into metals permits the signal to propagate throughout the tank floor as inside a bi-dimensional waveguide limited at the top and the bottom by the metal surface with the advantages of a poor dissipation of energy and a poor dispersion.

The data received by the sensor are sent to the data processing unit wherein a dedicated software implementing the algorithm according to the method of A. A Dzidziguri and L. SH Gavasheli previously referred to, which performs the spectral analysis and executes the dedicated algorithm for the recovering of the characteristics of the metal and for the detection and positioning of the anomalies. In particular, the algorithm takes into account the propagation time of the backscatterd signals determined by the defects and the amplitude of deviations of emission frequencies to provide a first diagram of the amplitude and position of defect. Taking into consideration inserting the geometrical data of the tank it is possible to calculate the position of each defect with respect to the energization point and to distinguish amongst very close positions, thus avoiding superposition of defects detected by different signal in the proximity of the centre of the tank.

The position of defects is indicated as vector coordinates from the origin of the vector at the centre of the tank.

To simplify the determination of the vector, the excitation points are used as orientation. The identification of the position of a cell from inside the tank during the repair works will be easy and precise following the following steps:
Identification of the tank centre (origin of the vector): it can be easily determined by using a metering tape and a few measurements.
Identification of the starting point and test points (origin of the sequence of test points): it will be very easy if the origin point was set in correspondence of defined manhole clearly visible from inside the tank. In the following examples the sequence is always counter clockwise, but it is obvious that this feature has not to be intended as limiting the scope of the patent. In order to identify the testing points along the internal circumference it is sufficient to remember the set interval among the points. This procedure takes a very short time using a metering tape and a wax marker.
Determination of vector and position: using the data obtained by the calculations, each cell will be identified easily by putting the origin point of a metering tape on the tank centre and connecting it to the desired testing point (this will identify the vector); the distance value previously calculated will provide the position in the metering tape and in the tank floor.

The following types of degradations are taken into consideration by the method according to the present invention:
hard loading;
hard loading under carbon corrosion;
hard loading under hydro-carbon corrosion;
hard loading under hydrogen saturation of the surface field;
low cyclic loading;
low cyclic loading under nitrite corrosion;
low cyclic loading under hydrogen-sulfide corrosion;
low cyclic loading under nitrite corrosion and hydrogen saturation in the whole volume;

and the following frequency and amplitude signal analysis are used for the data processing:

A_{mp.i}—Level of the amplitude in the frequency range of −fₘₚ.

fₘₚᵢ—Modulating high frequencies oriented on relaxing frequencies (81-435 Hz).

A_{mp.et}—etalon amplitude.

fₘₚ—frequency range.

A_{mc}—relative amplitude.

Cases in which A_{mp.i}<A_{mp.et} indicate not important layering and not developing significant fractures, while cases in which A_{mp.i}>A_{mp.et} indicate significant layering process and development of fractures.

The resonance of the screw dislocations spectrum characterizes the dimensions of defects and the propagation of the porous degradation. The presence of different levels of resonances in the whole range of spectrum indicates to the level of density of several degradation defects.

On one hand, the algorithm, according to the method of A. A Dzidziguri and L. SH Gavasheli previously referred to, provides revealed correlations between the configuration of the set of mechanical parameters, most important part of which are given in table 1, and characteristics and leading mechanisms of defect development (corrosion, mechanical etc.) in metals.

TABLE 1

| Parameter | Unit |
|---|---|
| Equivalent friction angle of the structural in-homogeneity | degree |
| Tensile strength, Hardness: | Mpa |
| Flowability limit: | Mpa |
| P-acoustic sound velocity: | m/s |
| Percent elongation: | % |
| Percent contraction: | % |
| Volume density: | t/m³ |
| Dynamic elasticity module: | Mpa |
| Cyclic cracking resistance | — |
| Prevision of residual life: | years |

On the other hand, the algorithm provides correlations between the induced acoustic emission parameters and configuration of the abovementioned mechanical parameters. Accordingly, the induced acoustic emission parameters on different frequencies reflect certain pattern of the mentioned set of mechanical parameters and correlating defect development process: shifts of resonance frequencies against etalon values specific for different types of degradation processes. The shifts of resonance frequencies within each of said six frequency ranges provide specific and complementary information about structural changes inside the object and can be used for description of flaw development.

The high level of the relative amplitude A_{mc}, provides information about the growing process of residual strains in metal. The presence of the similar level in nearby frequency ranges shows the occurrence of “flow-type” (flowability) corrosion. Comparison of maximal resonance with the minimal value of the frequency range (20.4-60.0 Hz) provides information regarding the approaching of accidental situations that at the moment are blocked only by a delicate equilibrium of different forces. Until the dislocation frequency (f_{cg-o}) will equal to 1890 Hz, the situation will not develop till the amplitude of low cycling frequency (A_{mc}) will reach its maximal level and the low cycling frequency (f_{mc}) will reach its minimal level.

The sliding resonance of edge dislocations permits to determine the dimensions of the defects (height, width and length). The level of resonance amplitude Aₘₚ gives information regarding the residual strain along the direction of signal transmission.

The calculation of the residual life is obtained by a combination of the above data, the most important of which is the coefficient of inhomogeneity of structural frictions.

The processing can be automatically managed by an internal software executing the dedicated algorithm at the accomplishment of all measurements. In order to consider all ray-paths crossing a cell it discharges from a repository the selected measured points, which ray-paths have crossed the cell and, by the application of a dedicated routine which consider the location of the cell, and consequently can identify the different ray-paths covering it, it applies the spectral analysis to that given point.

By this process, the software reconstructs the geometry of the defects by taking into consideration the contribution of a series of data acquisition points.

The process of data analysis above mentioned is repeated for each cell.

The cells are organised according to a vectorial position having origin in the centre of the tank and distance, in meters and decimetres, calculated by the analysis of numbers of the cycle of the signal.

As in a tomographical investigation, each cell is interested by different ray-paths and the contribution of the different ray-paths characteristics permits to solve the complicate matrix formed by all cells.

The detected defects or cluster of defects are located inside a cell (element of the matrix) that is precisely positioned in the tank due to the vector coordinates.

The advantages of the method for non-destructive investigation of the bottom of metallic tank structures according to the present invention are immediately evident for a person skilled in the art.

Moreover, if compared to other non-destructive testing methods, C.I.A.E.T. has the unique ability to identify not only the defects and their location, but also to estimate with the 95% accuracy the residual life and safe service conditions. Therefore, C.I.A.E.T. enables to cut down expenses necessary to keep serviceability of equipment.

Unlike ultrasonic, X-ray and magneto-metric defectoscopy, C.I.A.E.T. does not require point by point scanning of entire surface area of the tested object. Correspondingly, an accessibility of the whole surface does not stand out as a limiting factor for application of this methodology, nor do large dimensions of inspected object lead to long investigation time.

C.I.A.E.T. testing is applied without the need of putting the object out of service as well as expensive and time-consuming preliminary preparatory works (e.g. opening and cleaning of tanks).

Unlike traditional acoustic emission technique, which does not imply active probing of the structure, it measures the response to an artificial and repeatable acoustic excitation (2-4 kHz).

Unlike the traditional acoustic emission technique, focused on amplitude characteristics, which attenuates in material, C.I.A.E.T. considers the changes of the frequency characteristics (which are noise-proof parameters) in 6 different frequency ranges.

Unlike traditional acoustic emission technique mainly dealing with transient signals, C.I.A.E.T. is analyzing frequency characteristics of continuous acoustic emission signal.

Moreover, C.I.A.E.T. can determine the corrosion or mechanical defects of the bottom of an aboveground storage tank without opening and cleaning the tank.

C.I.A.E.T. can detect corrosion-caused defects even if the active corrosion is stopped for the moment; therefore the use of the method for non-destructive investigation of the bottom of metallic tank structures is not limited even when the product or tank conditions regularly change.

C.I.A.E.T. can be used for flaw detection, assessment of metal loss and micro-cracking in tank bottom and welding joints, as well as other mechanical defects. The method does not require stressing of the tank floor plates during any loading tests.

C.I.A.E.T. can be used for detecting holes and taps even when holes are isolated by sludge, debris or insulation material and no leakage occurs.

C.I.A.E.T. does not require either the isolation of tank from the sources of noise and closing valves or turning off mixers and heaters during testing procedures.

C.I.A.E.T. enables to determine almost all of the known physical-mechanical parameters of the material, used for description of metal degradation and flaw development, and consequently gives fundamental information regarding detected defects, like:
information on the type of defects and degradation process (mechanical defects, corrosion induced defects, type of corrosion etc.);
prognosis of defect development and estimation of residual life.

### EXAMPLE 1

### Comparison Amongst Different Tank Bottom Inspection Techniques

A storage tank, built in 1965 and opened for maintenance last time in 1994, was since then continuously maintained in use for the storage of automotive diesel.

The piece of equipment was the object of two inspection controls during use: the first with an analysis methodology based on the acoustic emission technique (in the following AE) and the second with the method for non-destructive investigation of the bottom of metallic tank structures according to the present invention, based on CIAET technology.

Subsequently, the tank was put out of service for general maintenance and application of a double bottom. At the same time an internal inspection was performed in order to verify the compatibility of the data obtained by said two controls, further comprising them with another possible control performed after the tank was cleaned and sandblasted: the magnetic flow technique or Floormap (in the following MFL).

Fundamental features of the tank are shown hereinbelow:
Construction type: fixed roof
External diameter 30480 mm
Height: 14630 mm
Actual capacity 10700 mc
Stored fluid: automotive diesel
Nominal thickness of the plates of the bottom 6.5 mm—material Fe 37/8
Nominal thickness of the plates of the stringer 8 mm—material Fe 42/8

The inspection of the tank in object by means of acoustic emissions (AE) detected the presence of a moderate degree of active corrosion, concentrated in particular at the centre of the tank.

FIG. 1 shows a two-dimensional representation of the bottom of the tank, with indication of the positioning of the source of energy, wherein the coordinates (X, Y) are expressed in centimeters.

The method for non-destructive investigation of the bottom of metallic tank structures according to the present invention gave results that evidenced the presence of corrosion uniformly distributed on the bottom of the tank itself with an maximum value of 2.5 mm. FIG. 2 shows the identification of a defect on the surface of the bottom of a tank, on the base of vector coordinates, while FIG. 3 shows the mapping of the bottom of the tank, as obtained through the application of the method of the invention, wherein corrosion points and corresponding detected values are shown.

Once the tank was opened, after it was cleaned and sandblasted, a MFL control of the bottom was performed.

Such a control, supported by visual inspection of the plates of the bottom, and further by performing feeler gauging on the plates, allowed to have a clear picture of the conditions of the bottom.

FIG. 4 shows the mapping of the bottom of the tank with the distribution of the percentages of residual thickness on the bottom itself obtained by the MFL report.

FIG. 5 shows the statistics of the number of discontinuity inside the tank, reporting on the horizontal axis the percentage of thickness reduction with respect to the nominal thickness as originally installed.

During the internal inspection the presence of reinforcement patches for about 30% of the surface of the bottom of the tank was revealed; such operation was performed during the last maintenance of the tank made in 1994.

The majority of the plates not covered by patches was interested by generalised corrosion, of an entity variable between 1.0 and 2.5 mm mostly concentrated in the North-East sectors, with areas reaching the depth of 3.0 mm and a couple of isolated craters with depth of about 3.5 mm (craters also detected in two plates in the south-west and south-east), as shown in FIG. 6.

In such area a repairing operation was required before the realisation of the double bottom, by means of the application of reinforcement plates as already made for other parts of the tank.

The internal inspection of the tank in object, together with the use of the MFL technology for controlling the bottom, allowed to have a quite clear picture both of the conditions of the tank and of the validity of the two control techniques used during the use of the tank.

The result obtained through the AE technology was “minor situation of degradation” of the tank, classifying it as “class A1”, and suggesting a repetition of the control in 3 years.

However, the typology of result and the position of the corrosive events in action did not come out to be, at least for the present case, very coherent with the subsequent internal inspection.

In fact, the analysis with AE methodology detected minor corrosion in action at the center of the tank, and did not detect any event neither in the part North of the tank (in particular on the stringer that turns out to be the most damaged part), nor in other points were a corrosion of about 2.5 mm was found.

The analysis performed with the method for non-destructive investigation of the bottom of metallic tank structures of the present invention, based on a different physical principle, gave as a result a generalised corrosion all over the tank.

It must be pointed out that, according to the physical theory on which the technology is based, the portion of the tank covered with patches turns out to be hidden since the acoustic wave passes through the plates positioned under the repaired part.

Taking into consideration the parts that are not hidden and investigated, it can be noted that there is more similarity of the return data obtained by this control than by the other: the maximum reduction of thickness of the tank detected by CIAET was close to 2.5 mm, against the 3.5 mm detected through visual inspection and also confirmed through MFL control.

Finally, acoustic emission techniques for the control of tanks in use sometimes gave results in conflict with the subsequent internal inspection. In the present case, the analysis with AE did not give any indication of corrosion on the stringer, the portion that, after visual inspection resulted to be the most damaged.

The method for non-destructive investigation of the bottom of metallic tank structures of the present invention demonstrated as a whole a pretty good coherence with the subsequent visual inspection (at least on a qualitative level).

The general conditions of the piece of equipment are in agreement with those detected from the control.

Nevertheless, it must be pointed out that part of the tank was “hidden” because of the presence of reinforcement plates (where it is not possible to make any comparison).

In conclusion, the method for non-destructive investigation of the bottom of metallic tank structures of the present invention gave results reliable as a whole.

It must be pointed out that, differently from AE, the method for non-destructive investigation of the bottom of metallic tank structures of the present invention does not involve the need of “stop of plant”: in fact, it is not sensible to all the external sources of noise existing for tanks (rain, leaking input/output valves, internal heating coils and vibrations coming from pumps upstream/downstream on the lines) causing, in a possible campaign of control of the tanks of the plant, an inevitable stop of the stop of production and further a well planned scheduling of the movement of the tanks.

### EXAMPLE 2

The goal of the survey was to test the floor of a tank having a diameter of 54 meters, for a comparison of results after the opening and cleaning of the tank.

The thickness of the plates is 8 mm and the metal is ASTM Grade C.

It is, in fact, a priority for the safety of any oil facility to control the level of corrosion of the tank and the related pipe network.

In this investigation it is important to consider the development of pores and sub-lamination determined by the different type of corrosions occurring at the tank bottom and the micro-cracks developed by loading and unloading cycles.

After a certain critical point identified as limit of residual life, the defects progressively develop determining the “rupture” or a critical state of the artefact in a short time.

This calculation can be obtained after C.I.A.E.T. tests pointed out the presence of sub-critical defects, thus having the possibility to analyze it and to forecast the development.

When the test is carried out at the first operative stages of the structure (i.e. with a low number of light loading/unloading cycles and in presence of no original defects) it could happen that no sub-critical defects are present; in this case the calculation of the residual life has no significance and a new parameter is taken into account: “time of stable performance”.

To calculate the residual life the test has to be repeated after the early development of sub-critical defects.

It could also happen for some special structures that the loading cycles could determine a temporary strengthening of the metal; this is the case of steel structures interested by compression loading or gun barrels.

The investigation has been carried out by using acoustic sensors (e.g. Robotron KD-45—Germany or Bruel & Kjaer KD-43,70—Denmark) specially adapted for this use and interlaced to a data acquisition system installed on a laptop.

The source of energy is a small hammer. The excitation and recording are provided by hitting with the metal at an interval of 0.5 m along the perimeter of the tank bottom.

The annular space at the contact between the tank wall and the bottom was cleaned to remove the soil accumulated by rain and wind between the tank's shell and the floor.

Then an origin point was identified and a sequence of excitation points at 50 cm intervals was set. The origin point was located in correspondence of manhole.

The sensors were located in contact with the tank bottom and the excitation occurred in the proximity of the sensor.

The sampling occurred every 50 cm till the entire perimeter was investigated; the tank having a diameter of 54 meters, it was covered by a sequence of 1020 sample points providing more that 6120 parameters that have to be processed.

The data received by the sensor were sent to the dedicated software for the spectral analysis and the subsequent processing for the recovering of the characteristics of the metal and for the detection and positioning of the anomalies.

The following types of degradations were taken into consideration: hard loading, hard loading under carbon corrosion, hard loading under hydro-carbon corrosion, hard loading under hydrogen saturation of the surface field, low cyclic loading, low cyclic loading under nitrite corrosion, low cyclic loading under hydrogen-sulfide corrosion, low cyclic loading under nitrite corrosion and hydrogen saturation in the whole volume and the following frequency and amplitude signal analysis are used for the data processing: A_{mp.i} (level of the amplitude in the frequency range of −fₘₚ), fₘₚᵢ; (modulating high frequencies oriented on relaxing frequencies (81-435 Hertz)), A_{mp.et} (etalon amplitude; A_{mp.i}<A_{mp.et} indicates not important layering and not developing significant fractures, A_{mp.i}>A_{mp.et} indicates significant layering process and development of fractures), fₘₚ (frequency range), A_{mc} (relative amplitude).

Data were displayed in form of tables, diagrams and spectrograms providing the information for the calculation of position, dimensions and type of defects.

The processing was automatically managed by the internal software at the accomplishment of all measurements. Having to consider of all ray-paths crossing a cell, it discharged form the hard disk the selected measured points, which ray-paths crossed the cell and, by the application of a dedicated routine, it applied the data analysis (spectral analysis) to that given point.

By this process, the software reconstructed the geometry of the defects by taking into consideration the contribution of a series of data acquisition points.

The tank bottom was divided in a number of cells having the dimensions of the sampling interval, in the present case of 50×50 cm; giving more than 9100 cells for the tank.

The process of data analysis above mentioned was repeated for each cell.

The cells were organised according to a vectorial position having origin in the centre of the tank and distance, in meters and decimetres, calculated by the two-way time from energization and reflection.

As in a tomographical investigation, each cell was interested by different ray-paths and the contribution of the different ray-paths characteristics permitted to solve the complicate matrix formed by all cells.

The detected defects or cluster of defects were located inside a cell (element of the matrix) that was precisely positioned in the tank due to the vector coordinates.

The used representation for the tank bottom was a combination of drawings depicting the positions of all anomalies and defects and a series of explicative tables describing the residual characteristics of the metal and the position of main defects.

Each cell presenting a defect was characterised by a number referring to the specific table where the details and position of the defect could be found. This permitted an easier identification of the point from inside the tank during the repair works.

Due to the very high resolution of the method for non-destructive investigation of the bottom of metallic tank structures according to the present invention, a great number of defects was identified but the greatest part of them were not affecting the floor integrity, as it could be seen from the evaluation of their residual life.

The detail of each defect, size (area and thickness in millimetres), coordinates (referred to the Vector in meters) and calculation of residual life (years) before the irreversible and fast development of the defect, was specified in tables.

The possibility to determine the maximal dimensions of defects is one of the advantages provided by the C.I.A.E.T. methodology; it allows in fact to extract information about the dimensions of defects by the study of the recorded signals.

The position of defects is indicated as vector coordinates in metres, from the origin of the vector at the centre of the tank as according to the following example:

Defect n° 364; excitation point 122, Distance 26.5.

It represents a defect (n° 364) located along the vector 122 (the vector from tank centre to test point 122); the cell containing the defect is located at 26.5 metres from the origin of the Vector (tank centre).

The prevision of residual life indicates the number of years the structure could be maintained in service before the fast development of irreversible and dangerous defects.

It was calculated with the same working conditions in term of type of product, number of cycles, weather conditions, maintenance and the other parameters characterising the working and protection operations.

Many other parameters regarding the physics of the metal can be obtained from the data analysis and form the intermediate steps of the data processing.

Among them it is important to point out the energy intensity required for destruction of metal bonds (MJ/mc) and the limit of critical state of the metal (adim. Range 0.1-0.3). They are mentioned to point out the high number of parameters being considered in this investigation and for the calculation of the residual life of the metal.

The application of the Compulsory Induced Acoustic Emission Technique for the study of the floor of tanks permitted to obtain a very detailed map of the defects, allowed the calculation of their dimensions and provided precise indications about the residual life of the structures.

It also pointed out the great advantages of this technique in term of time, accuracy and resources dedicated to the study.

The situation of the tank was summarised as follows.

The risk of leaking was calculated to be very low, the bottom of the tank was in good conditions and the maximum defect had a depth thickness of 3.4 mm and the maximum area of 112.8 mm² allowing a residual life of more than 7.6 years before the critical development. Considering the initial thickness of 8 mm it did not represent a risk for the floor integrity.

The study confirmed the great advantages provided by C.I.A.E.T that permitted to collect data about the floor of tank in one day of data collection without any disturbance to the normal operation of the deposit.

### EXAMPLE 3

The goal of the survey was to test the floor of a tank having a diameter of 80 meters, for a further comparison of results after the opening and cleaning of the tank.

Its bottom was characterised by a gentle inclination toward a sumping pit with a diameter of 6 metres. The thickness of the plates was 6.4 mm and the metal was ASTM Grade C produced by Thyssen Stahl AG—Germany.

The investigation was carried out by using acoustic sensors (e.g. Robotron KD-45—Germany or Bruel & Kjaer KD-43,70—Denmark) specially adapted for this use and interlaced to a data acquisition system installed on a laptop.

The source of energy was a small hammer having a focusing system like Fresnel's zonal screen and a triggering device. The excitation and recording are provided by hitting with the metal at an interval of 0.5 m all along the perimeter of the tank bottom.

The first step was the cleaning of the annular space at the contact between the tank wall and the bottom to remove the soil accumulated by rain and wind; it was also necessary to remove a Sikadur Combiflex membrane covering the junction between the tank's shell and the floor.

The second step was the identification of the origin point and the setting of the sequence of excitation points at 50 cm intervals. The origin points was located in correspondence of the inlet pipe; origin and excitation points were indicated by painted markers on the tank's shell.

The sensors were located in contact with the tank bottom and the excitation occurred in the proximity of each sensor.

The data received by the sensor were sent to the dedicated software for the spectral analysis and the subsequent processing for the recovering of the characteristics of the metal and for the detection and positioning of the anomalies.

The following types of degradations were taken into consideration: hard loading, hard loading under carbon corrosion, hard loading under hydro-carbon corrosion, hard loading under the hydrogen saturation of the surface field, low cyclic loading, low cyclic loading under nitrite corrosion, low cyclic loading under hydrogen-sulfide corrosion, low cyclic loading under nitrite corrosion and hydrogen saturation in the whole volume; and the following frequency and amplitude signal analysis are used for the data processing: A_{mp.i} (level of the amplitude in the frequency range of −fₘₚ), fₘₚᵢ (modulating high frequencies oriented on relaxing frequencies (81-435 Hertz)), A_{mp.et} (etalon amplitude; A_{mp.i}<A_{mp.et} indicates not important layering and not developing significant fractures, A_{mp.i}>A_{mp.et} indicates significant layering process and development of fractures), fₘₚ (frequency range), A_{mc} (relative amplitude)

Data were displayed in form of tables, diagrams and spectrograms providing the information for the calculation of position, dimensions and type of defects.

The processing was automatically managed by the internal software at the accomplishment of all measurements. Having to consider of all ray-paths crossing a cell, it discharged form the hard disk the selected measured points, which ray-paths crossed the cell and, by the application of a dedicated routine, it applied the data analysis (spectral analysis) to that given point.

By this process, the software reconstructed the geometry of the defects by taking into consideration the contribution of a series of data acquisition points.

The tank bottom was divided in a number of cells having the dimensions of the sampling interval, in the present case of 50×50 cm; giving more than 20100 cells for the tank of the example.

The process of data analysis above mentioned was repeated for each cell.

The cells were organised according to a vectorial position having origin in the centre of the tank and distance, in meters and decimetres, calculated by the analysis of numbers of the cycle of the signal.

As in a tomographical investigation each cell was interested by different ray-paths and the contribution of the different ray-paths characteristics permitted to solve the complicate matrix formed by all cells.

The detected defects or cluster of defects were located inside a cell (element of the matrix) that was precisely positioned in the tank due to the vector coordinates.

The used representation for the tank bottom was a combination of drawings depicting the positions of all anomalies and defects and a series of explicative tables describing the residual characteristics of the metal and the position of main defects.

Each cell presenting a defect was characterised by a number referring to the specific table where the details and position of the defect could be found. This permitted an easier identification of the point from inside the tank during the repair works.

Data were organised in drawings and tables referring to the investigated structures.

Drawings depicted the position of defects in the tank floor.

Diagrams depicted the thickness of defects (thickness of corrosion, cracks, delamination etc), their area (in mm²) and the residual life (RL=years); the study of the diagrams permitted to select the defects of interests and the associated tables provided the numerical data and the position.

Due to the very high resolution of the methodology a great number of defects was identified but the greatest part of them were not affecting the floor integrity, as it could be seen from the high values of residual life.

The application of the Compulsory Induced Acoustic Emission Technique for the study of the floor of the tank of the present example permitted to obtain a very detailed map of the defects, allowed for the calculation of their dimensions and provided precise indications about the residual life of the structures.

It also pointed out the great advantages of this technique in term of time, accuracy and resources dedicated to the study.

The situation of the tank was summarised as follows.

The risk of leaking was very low. The bottom of the tank was in good conditions and the maximum defect had a depth thickness of 2.5 mm allowing a residual life of more than 7 years before the critical development. Considering the initial thickness of 6.4 mm it did not represent a risk for the floor integrity. It does not show any further development and its residual life can be safely compared with the average value of smaller defects.

The present invention was described for illustrative, non-limitative purposes, according to its preferred embodiments, but it is to be understood that variations and/or modification can be made by those skilled in the art without for these reasons escaping the pertinent scope of protection, as defined by the enclosed claims.

1. Method for non-destructive investigation of the bottom of metallic tank structures, characterized in that it comprises the following steps:
a) positioning an acoustic sensor at a point of contact between the tank wall and the bottom;
b) submitting the structure to induced acoustic emission signals caused by a source of energy in close proximity with the position of the acoustic sensor;
c) collecting data by the sensor and recording it;
d) moving to a different position at an interval of 0.1-1.0 m along the perimeter of the tank bottom;
e) repeating steps a)-d) until the entire perimeter of the bottom of the tank is investigated;
f) determining the position and amplitude of all the defects, by considering the physical-mechanical features of the metal, the geometry of the tank, the propagation time of the backscattered signals determined by the defects and the amplitude of deviations from standard values of emission frequencies;
g) performing the spectral analysis and data interpretation by considering the physical-mechanical features of the metal, the features of the induced acoustic emission signals, in particular the shift of the resonance frequencies of induced acoustic emission signals against the etalon values of frequencies of the intact metal and against etalon values specific for different types of degradation processes.

2. Method for non-destructive investigation of the bottom of metallic tank structures according to claim 1, characterized in that it further comprises a preliminary step of cleaning of the annular space at the contact between the tank wall and the bottom to permit a good coupling of the sensor with the metal.

3. Method for non-destructive investigation of the bottom of metallic tank structures according to claim 1, characterized in that said induced acoustic emission signals are submitted in six different frequency ranges from 0-16; 16-50; 50-450; 450-1900; 1900-2700 and 2700-50000 Hz.

4. Method for non-destructive investigation of the bottom of metallic tank structures according to claim 1, characterised in that said source of energy is a small hammer having a focusing system like Fresnel's zonal screen and a triggering device.

5. Method for non-destructive investigation of the bottom of metallic tank structures according to claim 1, characterised in that it comprises an algorithm for the automation of the process of spectral analysis and data interpretation.

6. Method for non-destructive investigation of the bottom of metallic tank structures according to claim 5, characterised in that a data acquisition system connected with the sensor is installed on an electronic calculator, also implementing a database containing physical-mechanical features of different metals and performing said algorithm.
